(19) United States
(12) Patent Application Publication
(10) Pub. No.: US 2026/0369246 A1
(43) Pub. Date: Nov. 19, 2026

(54) DISPLAY DEVICE WITH MULTI-POWER DELIVERY FUNCTION AND OPERATING METHOD THEREOF

(71) Applicant: Wistron Corporation, New Taipei City (TW)

(72) Inventors: LEI SUN, New Taipei City (TW); LEI YANG, New Taipei City (TW); LI XING ZHU, New Taipei City (TW); WENLONG YANG, New Taipei City (TW); JUNXIN QIU, New Taipei City (TW)

(21) Appl. No.: 19/260,999

(22) Filed: Jul. 7, 2025

(30) Foreign Application Priority Data
May 16, 2025 (CN) 202510637044.3

(51) Int. Cl. G09G 5/00; G06F 1/18

(52) U.S. Cl. CPC G09G 5/006; G06F 1/189; G09G 2330/021

(57) ABSTRACT

A display device with multi-power delivery (PD) function and operating method thereof are provided. The display device includes an internal power supply, a system load, an interface and a power synergy control circuit. The power synergy control circuit includes a first processing circuit, a second processing circuit and a driving circuit. The first processing circuit is electrically connected to the interface and determines whether the interface has PD capability to generate a first signal. The second processing circuit is electrically connected to a PD path between the interface and system load, and senses a power supply on the PD path to generate a second signal. The driving circuit is electrically connected to the first processing circuit and second processing circuit, and selectively determines the internal power supply and/or the interface to provide power to the system load according to the first signal and second signal.

### CROSS-REFERENCE TO RELATED APPLICATION

This application claims priority to and the benefit of China Application Serial No. 202510637044.3, filed in the China National Intellectual Property Administration (CNIPA) on May 16, 2025, the entire content of which is incorporated herein by reference as if fully set forth below in its entirety and for all applicable purposes.

### TECHNICAL FIELD

The present disclosure relates to a display, more particularly, to a display device with multi-power delivery (PD) function and an operating method thereof.

### BACKGROUND

With the development of universal serial bus (USB) Type-C, Thunderbolt (TBT) and PD technologies, USB Type-C interfaces are usually used as both signal transmission interfaces and power ports in almost all current mobile devices such as notebooks and mobile phones. As for display devices, the PD function is usually added to the TBT or USB Type-C input interface of the display in current designs.

Ideally, it is hoped that the display device has multi-PD function to simultaneously provide power to a plurality of external devices. However, in reality, it is still difficult to achieve due to factors such as excessive increase in power, balanced display function, peripheral interface power supply function, efficiency under various loads, and bottlenecks in high-power output of power boards. Even if the power board of the display device is designed to be a dynamic allocation type, after the power board preferentially allocates power to the internal system, the remaining power may not fully meet the power supply needs of the external devices, resulting in a significant reduction in the power absorption capacity of the external devices, and even affecting the operation of certain functions.

In addition, electronic waste has become a global issue, including a large number of unused or discarded power adapters. Therefore, it is also an important issue that how to effectively reuse these idle power adapters to reduce the generation of electronic waste and simultaneously reduce the resource consumption and carbon footprint caused by manufacturing new power adapters to assist in environmental sustainability and cannot be delayed.

### SUMMARY

In view of this, a display device with multi-PD function and an operating method thereof are proposed in the present disclosure to effectively solve the above-mentioned problems in the prior art.

An embodiment of the present disclosure is a display device with multi-PD function. In this embodiment, the display device includes an internal power supply, a system load, an interface and a power synergy control circuit. The power synergy control circuit is electrically connected to the internal power supply, the system load and the interface respectively. The power synergy control circuit includes a first processing circuit, a second processing circuit and a driving circuit. The first processing circuit is electrically connected to the interface and configured to determine whether the interface has PD capability and generate a first signal. The second processing circuit is electrically connected to a PD path between the interface and the system load and configured to sense a power supply on the PD path and generate a second signal. The driving circuit is electrically connected to the first processing circuit and the second processing circuit and configured to selectively determine the internal power supply and/or the interface to provide power to the system load according to the first signal and the second signal.

An embodiment of the present disclosure is an operating method of a display device with multi-PD function. In this embodiment, the display device includes an internal power supply, a system load, an interface and a power synergy control circuit. The operating method includes: determining whether the interface has PD capability through the power synergy control circuit and generating a first signal accordingly; sensing a power supply on the PD path between the interface and the system load and generating a second signal accordingly; and selectively determining the internal power supply and/or the interface to provide power to the system load according to the first signal and the second signal.

### BRIEF DESCRIPTION OF THE DRAWINGS

FIG. 1 is a schematic diagram illustrating a display device with multi-PD function electrically connected to a power adapter with PD capability in one embodiment of the present disclosure.

FIG. 2 is a schematic diagram illustrating a display device with multi-PD function in one embodiment of the present disclosure.

FIG. 3 is a schematic diagram illustrating a power supply state when the display device in FIG. 2 is not electrically connected to a power adapter.

FIG. 4 is a schematic diagram illustrating a power supply state when the display device in FIG. 2 is electrically connected to a power adapter.

FIG. 5 is a schematic diagram illustrating a power synergy control circuit in one embodiment of the present disclosure.

FIG. 6 is a curve chart illustrating a corresponding relationship between a forward current and a forward voltage of a Schottky diode.

FIG. 7 is a schematic diagram illustrating a display device with multi-PD function in one embodiment of the present disclosure.

FIG. 8 is a schematic diagram illustrating a current sensing circuit in one embodiment of the present disclosure.

FIG. 9A to FIG. 9D are schematic diagrams illustrating different comparison results of a positive input terminal voltage and a negative input terminal voltage of a driving circuit and the output pull current.

FIG. 10 is a flowchart illustrating an operating method of a display device with multi-PD function in one embodiment of the present disclosure.

### DETAILED DESCRIPTION

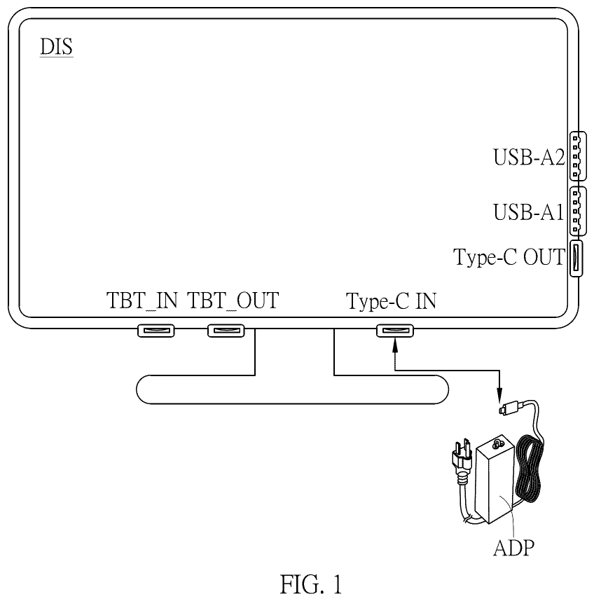

The following describes the implementation methods disclosed in the present disclosure through specific embodiments in conjunction with FIG. 1 to FIG. 10. Those skilled in the art may understand the advantages and effects of the present disclosure from the contents disclosed in this specification. However, the following disclosure is not intended to limit the protection scope of the present disclosure.

The structures shown in the drawings of the present disclosure are not drawn according to the shape and size ratios of actual implementation. For example, the sizes of certain elements are exaggerated for convenience of explanation.

Further, it will be understood that when an element is referred to as being “connected to” another element, it may be directly coupled to the other element or indirectly coupled to the other element, or intervening elements may be present. As used herein, “electrical connection” may refer to a physical and/or non-physical electrical connection, or may be a wired and/or wireless electrical connection.

It should be understood that, although the terms “first”, “second”, “third”, etc. may be used herein to describe various elements, these elements should not be limited by these terms. These terms are only used to distinguish one element from another. Thus, a “first element” discussed below could be termed a second element without departing from the teachings herein.

An embodiment of the present disclosure is a display device with multi-PD function. In this embodiment, the display device with multi-PD function includes a plurality of interfaces for electrically connecting to different types of electronic devices, such as a notebook, a mobile phone, a tablet computer, a speaker, a desk lamp and a power adapter.

For example, please refer to FIG. 1, the display device DIS with multi-PD function includes a plurality of interfaces of different types, such as a first interface Type-C IN, a second interface Type-C OUT, a third interface TBT_IN, a fourth interface TBT_OUT, a fifth interface USB-A1 and a sixth interface USB-A2. It should be noted that although FIG. 1 shows an external power supply device with PD capability, such as a power adapter ADP, which is electrically connected to the first interface Type-C IN of the display device DIS, in other embodiments, the power adapter ADP may also be electrically connected to other interfaces of the display device DIS, such as the second interface Type-C OUT, the third interface TBT_IN, the fourth interface TBT_OUT, etc., and not limited to this example.

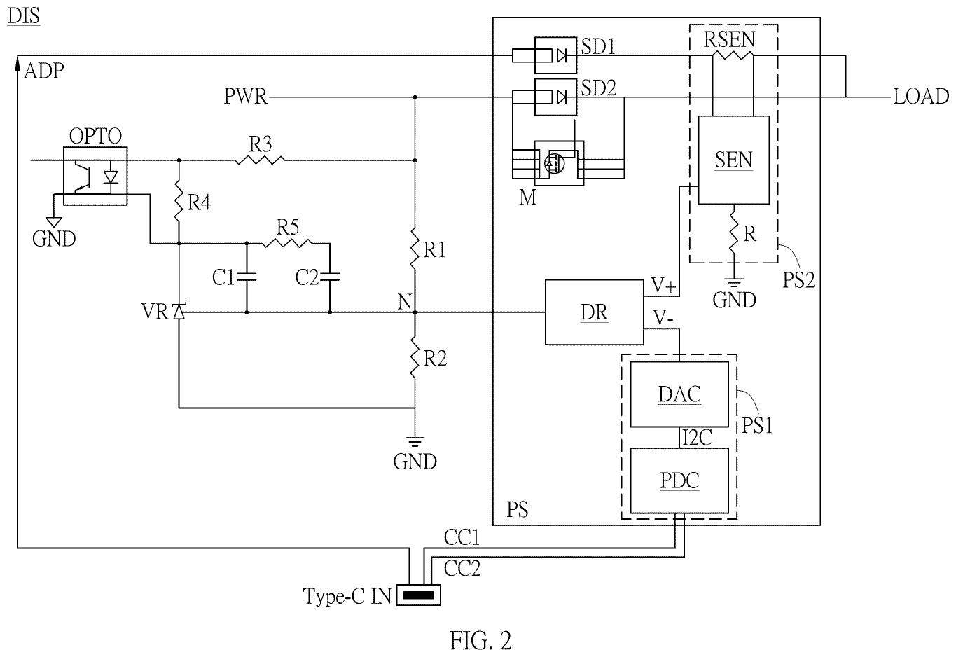

Please refer to FIG. 2. FIG. 2 is a schematic diagram illustrating a display device with multi-PD function in one embodiment of the present disclosure. As shown in FIG. 2, the display device DIS with multi-PD function includes an interface Type-C IN, a power synergy control circuit PS, an internal power supply PWR, a system load LOAD, an optical coupler OPTO, a regulator VR, resistors R1~R5 and capacitors C1~C2. The first resistor R1 and the second resistor R2 are connected in series between the internal power supply PWR and a ground terminal GND. The voltage regulator VR is electrically connected between the optical coupler OPTO and the ground terminal GND. The voltage regulator VR is an adjustable shunt regulator with three terminals, and may be an adjustable precision shunt regulator (TL431), but not limited to this. The third resistor R3 is electrically connected between the internal power supply PWR and the optical coupler OPTO. The fourth resistor R4 is electrically connected between the optical coupler OPTO and the voltage regulator VR. The fifth resistor R5 is electrically connected to the optical coupler OPTO, the fourth resistor R4 and the voltage regulator VR respectively. One terminal of the first capacitor C1 is electrically connected between the fifth resistor R5 and the optical coupler OPTO, and the other terminal of the first capacitor C1 is electrically connected between the regulator VR and a node N. The second capacitor C2 is electrically connected between the fifth resistor R5 and the node N. The power synergy control circuit PS is electrically connected to the interface Type-C IN, the internal power PWR and the system load LOAD respectively.

In one embodiment, the power synergy control circuit PS includes a first processing circuit PS1, a second processing circuit PS2 and a driving circuit DR. The first processing circuit PS1 is electrically connected to the interface Type-C IN and the driving circuit DR and configured to determine whether the interface Type-C IN has PD capability and generate a first signal (i.e., a negative input voltage V−) to the driving circuit DR. The second processing circuit PS2 is electrically connected to a PD path between the interface Type-C IN and the system load LOAD and the driving circuit DR and configured to sense the power supply on the PD path and generate a second signal (i.e., a positive input terminal voltage V+) to the driving circuit DR. The driving circuit DR is electrically connected to the first processing circuit PS1 and the second processing circuit PS2 respectively and configured to selectively determine whether the internal power supply PWR and/or the interface Type-C IN are used to provide power to the system load LOAD according to the first signal (i.e., the negative input terminal voltage V−) and the second signal (i.e., the positive input terminal voltage V+).

In detail, the first processing circuit PS1 of the power synergy control circuit PS includes a power supply control circuit PDC and a digital-to-analog converter DAC. The power supply control circuit PDC is electrically connected to the interface Type-C IN and the digital-to-analog converter DAC respectively. The digital-to-analog converter DAC is electrically connected to the power supply control circuit PDC and the driving circuit DR respectively. The power supply control circuit PDC is configured to communicate power supply protocol with the interface Type-C IN through the bus CC1~CC2 to obtain a PD capability information of the interface Type-C IN, such as the voltage value (e.g. 20V) and current value (e.g. 5 A) of the maximum power data object (PDO) and determine whether the interface Type-C IN has the PD capability accordingly. The power supply control circuit PDC may also notify the digital-to-analog converter DAC through the bus I2C to generate a standard reference voltage that is proportional to the current value (e.g., 5A) according to the current value in the PD capability information (e.g., maximum PDO) as the first signal (i.e., the negative input terminal voltage V−) to be outputted to the driving circuit DR, but not limited to this.

The second processing circuit PS2 of the power synergy control circuit PS includes a sensing resistor RSEN, a current sensing circuit SEN and a resistor R. The sensing resistor RSEN is disposed on the PD path between the interface Type-C IN and the system load LOAD. The current sensing circuit SEN is electrically connected to two terminals of the sensing resistor RSEN, the driving circuit DR and the resistor R respectively. The resistor R is electrically connected between the current sensing circuit SEN and the ground terminal GND. The current sensing circuit SEN is configured to sense a power supply current flowing through the sensing resistor RSEN and convert the power supply current into a voltage signal as a second signal (i.e., the positive input terminal voltage V+) to be outputted to the driving circuit DR.

In addition, the power synergy control circuit PS also includes high-power Schottky diodes SD1~SD2 and a power transistor M. The high-power Schottky diode SD1 is electrically connected between the interface Type-C IN and the sensing resistor RSEN. The sensing resistor RSEN is electrically connected between the high-power Schottky diode SD1 and the system load LOAD. The high-power Schottky diode SD2 is electrically connected between the internal power supply PWR and the system load LOAD. The power transistor M is electrically connected to two terminals of the high-power Schottky diode SD2 respectively.

It should be noted that the power synergy control circuit PS selectively switches different power supply states of the system load LOAD according to whether the interface Type-C IN of the display device DIS is electrically connected to an external power supply device with a power supply function (such as a power adapter) and whether the system load LOAD is a light load or a heavy load.

For example, when the interface Type-C IN of the display device DIS is not electrically connected to any external power supply device with PD function (such as a power adapter ADP), the power synergy control circuit PS may switch the power supply state of the system load LOAD to a state that the internal power supply PWR is fully responsible for the power supply of the system load LOAD based on a comparison result that the positive input terminal voltage V+ of its driving circuit DR is equal to 0 and the negative input terminal voltage V− of the driving circuit DR is equal to 0. At this time, the power transistor M is turned on, so that the internal power PWR provides power to the system load LOAD through the turned-on power transistor M instead of through the second high-power Schottky diode SD2, so the power consumption can be reduced.

When the interface Type-C IN of the display device DIS is electrically connected to an external power supply device with PD function (such as a power adapter ADP), the power synergy control circuit PS may further determine whether the system load LOAD is a light load or a heavy load based on the comparison result of whether the positive input terminal voltage V+ of its driving circuit DR is less than the negative input terminal voltage V −of the driving circuit DR.

When the positive input voltage V+ of the driving circuit DR is less than the negative input voltage V− of the driving circuit DR, the power synergy control circuit PS may determine that the system load LOAD is a light load, and the driving circuit DR outputs an output pull current IOUT equal to 0. The power synergy control circuit PS may switch the power supply state of the system load LOAD to a state that the power adapter ADP externally connected to the interface Type-C IN is almost fully responsible for the power supply of the system load LOAD, while the internal power supply PWR consumes almost no load, so as to save power of the internal power supply PWR. At this time, the interface Type-C IN may provide power to the system load LOAD through the first high-power Schottky diode SD1 and the sensing resistor RSEN in sequence according to its PD path.

When the positive input voltage V+ of the driving circuit DR is greater than or equal to the negative input voltage V− of the driving circuit DR, the power synergy control circuit PS may determine that the system load LOAD is overloaded, and the driving circuit DR outputs an output pull current IOUT greater than 0. The power synergy control circuit PS may switch the power supply state of the system load LOAD to a state that the internal power supply PWR and the power adapter ADP externally connected to the interface Type-C IN are jointly responsible for the power supply of the system load LOAD, and the power adapter ADP externally connected to the interface Type-C IN will fully provide its maximum PD capacity to the system load LOAD to save power of the internal power supply PWR as much as possible. At this time, the power transistor M is turned off and the internal power PWR provides power to the system load LOAD through the second high power Schottky diode SD2.

In detail, when the interface Type-C IN of the display device DIS is electrically connected to a power adapter ADP with PD function, the power supply control circuit PDC may communicate a power supply protocol with the power adapter ADP through the bus CC1~CC2 to obtain the maximum power data object (PDO) of the power adapter ADP, for example, 20V/5 A. At the same time, the power supply control circuit PDC notifies the digital-to-analog converter DAC through the bus I2C to output a standard reference voltage (i.e., the negative input voltage V−) that is proportional to the maximum PDO current (e.g., 5 A) to the negative input terminal-of the driving circuit DR. The current sensing circuit SEN senses the current at both terminals of the sensing resistor RSEN to convert the actual power supply current flowing through the PD path of the power adapter ADP into a voltage signal (i.e., the positive input terminal voltage V+) and then input the voltage signal to the positive input terminal+of the driving circuit DR.

When the positive input terminal 30 and the negative input terminal-of the driving circuit DR receive the positive input terminal voltage V+ and the negative input terminal voltage V− respectively, the driving circuit DR compares the positive input terminal voltage V+ with the negative input terminal voltage V−. When a comparison result of the driving circuit DR is that the positive input terminal voltage V+ is greater than the negative input terminal voltage V−, the output current IOUT outputted by the output terminal of the driving circuit DR is the output pull current. When the comparison result of the driving circuit DR is that the positive input terminal voltage V+ is less than the negative input terminal voltage V−, the output current IOUT outputted by the output terminal of the driving circuit DR is equal to 0.

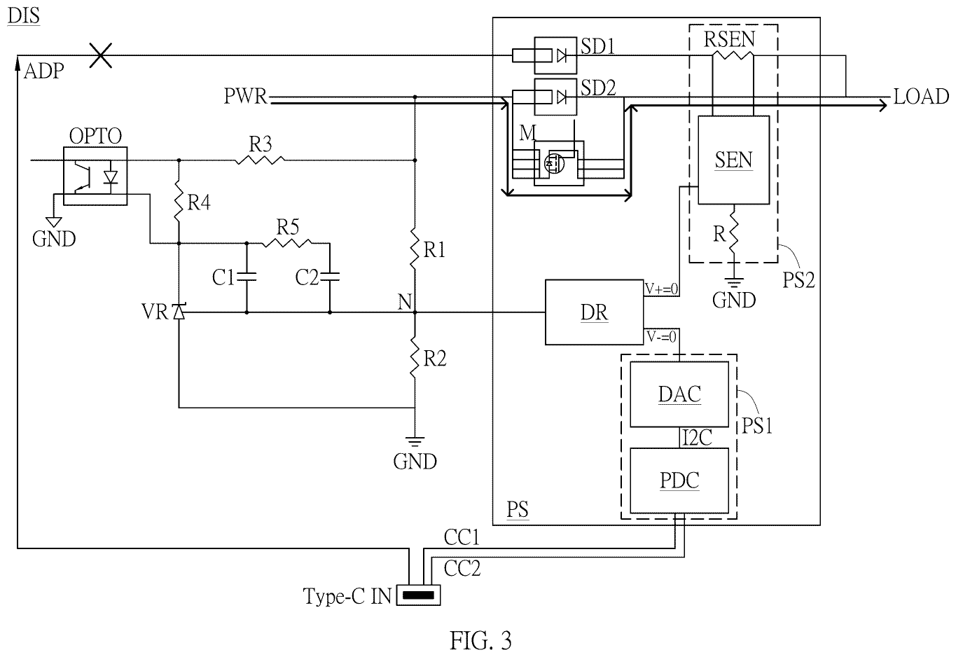

Please refer to FIG. 3. If no power adapter with PD function is connected to the display device DIS, the power supply of the system load LOAD will be completely provided by the internal power supply PWR of the display device DIS. At this time, a scaler of the display device DIS does not detect the source attachment information and control the power transistor M to be turned on, so that the PD path from the internal power supply PWR of the display device DIS to the system load LOAD will pass through the turned-on power transistor M instead of the high-power Schottky diode SD2, thereby reducing power consumption.

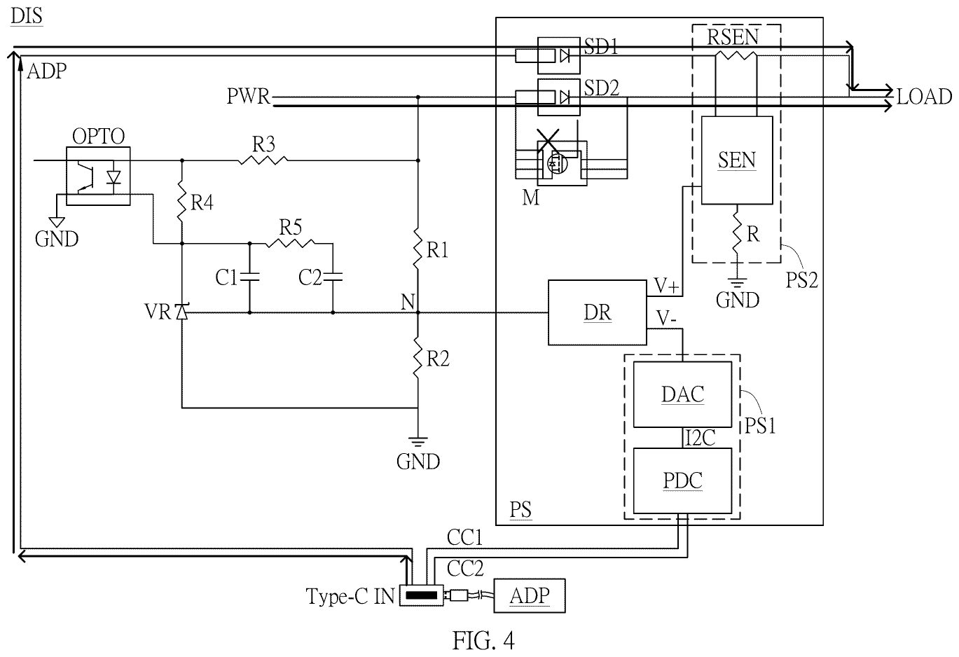

Please refer to FIG. 4. When the power adapter ADP with PD function is electrically connected to the interface Type-C IN of the display device DIS, the calibrator of the display device DIS detects the source attachment information and controls the power transistor M to be turned off, so that the power supply of the system load LOAD will be jointly provided by the internal power supply PWR of the display device DIS and the external power adapter ADP. At this time, the PD path from the power adapter ADP to the system load LOAD passes through the high-power Schottky diode SD1, and the PD path from the internal power PWR of the display device DIS to the system load LOAD passes through the high-power Schottky diode SD2 instead of the turned-off power transistor M. It should be noted that the power adapter ADP may operate at its maximum power output state, and the feedback (FB) of the internal power supply PWR will be affected by the corresponding sink current or pull current to adjust its output voltage so as to cooperate with the power adapter ADP to provide power to the system load LOAD at its maximum PD capacity.

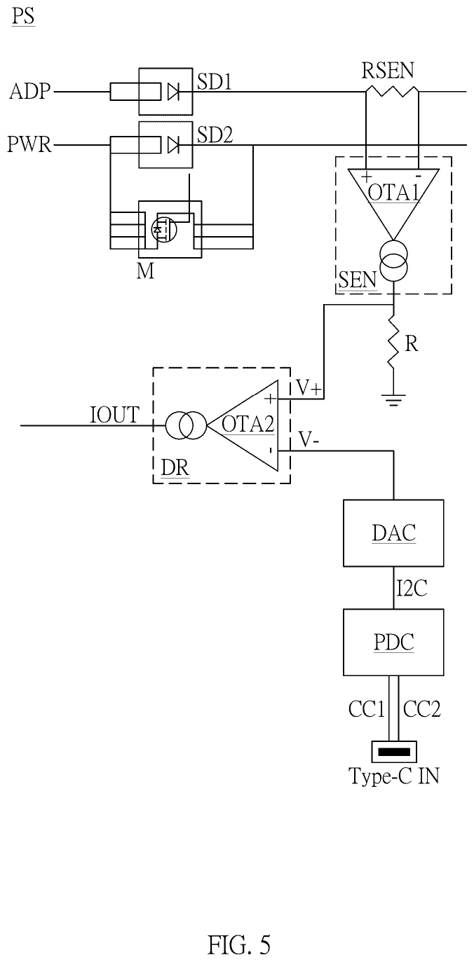

In one embodiment, as shown in FIG. 5, the current sensing circuit SEN in the power synergy control circuit PS includes an operational transconductance amplifier OTA1 and the driving circuit DR in the power synergy control circuit PS includes an operational transconductance amplifier OTA2. The combination of the power supply control circuit PDC and the digital-to-analog converter DAC converts the current (e.g., 5 A) of the maximum PDO of the power adapter ADP actually obtained into a standard reference voltage as the first signal (i.e., the negative input terminal voltage V−) and inputs it to the negative input terminal−of the operational transconductance amplifier OTA2. The positive input terminal+and the negative input terminal—of the operational transconductance amplifier OTA1 are electrically connected to both terminals of the sensing resistor RSEN respectively, and the output terminal of the operational transconductance amplifier OTA1 is electrically connected to the resistor R and the positive input terminal +of the operational transconductance amplifier OTA2.

Next, the operational transconductance amplifier OTA2 compares the first signal (i.e., the negative input terminal voltage V−) with the second signal (i.e., the positive input terminal voltage V+ ). When the second signal (i.e., the positive input terminal voltage V+ ) is greater than the first signal (i.e., the negative input terminal voltage V−), the output terminal of the operational transconductance amplifier OTA2 will pull current (i.e., the output current IOUT of the operational transconductance amplifier OTA2 is the output pull current). When the second signal (i.e., the positive input terminal voltage V+ ) is smaller than the first signal (i.e., the negative input terminal voltage V−), the output terminal of the operational transconductance amplifier OTA2 will sink current (i.e., the output current IOUT of the operational transconductance amplifier OTA2 is the output sink current).

When the power adapter ADP is connected to the interface Type-C IN, the power supply control circuit PDC will communicate the power supply protocol through the bus CC 1~CC2 to obtain the maximum PDO of the power adapter ADP, such as 20V/5A. At the same time, the power supply control circuit PDC notifies the digital-to-analog converter DAC through the bus I2C to output a standard reference voltage that is proportional to the current of the maximum PDO as the first signal (i.e., the negative input terminal voltage V−) to the negative input terminal-of the operational transconductance amplifier OTA2.

It should be noted that the main function of the digital-to-analog converter DAC is to convert digital signals into analog signals. Its basic principle is to convert a series of binary bit input words into a continuous-time output voltage corresponding to these digital values. This conversion process involves the understanding of quantization levels, that is, each digital bit value corresponds to a specific level of analog output. The important technical indicators and parameters of the digital-to-analog converters (DACs) are resolution/bit number. The analog quantity output by an n-bit digital-to-analog converter DAC has a maximum of 2ⁿ different values. For example, the separable levels of the output voltage of an 8-bit digital-to-analog converter DAC are 2⁸=256; the separable levels of the output voltage of a 12-bit digital-to-analog converter DAC are 2¹²=4096. The resolution is 1/(2ⁿ−1)*VREF. In other words, the higher the bit number of the digital-to-analog converter DAC, the more delicate and accurate the output voltage of the digital-to-analog converter DAC will be.

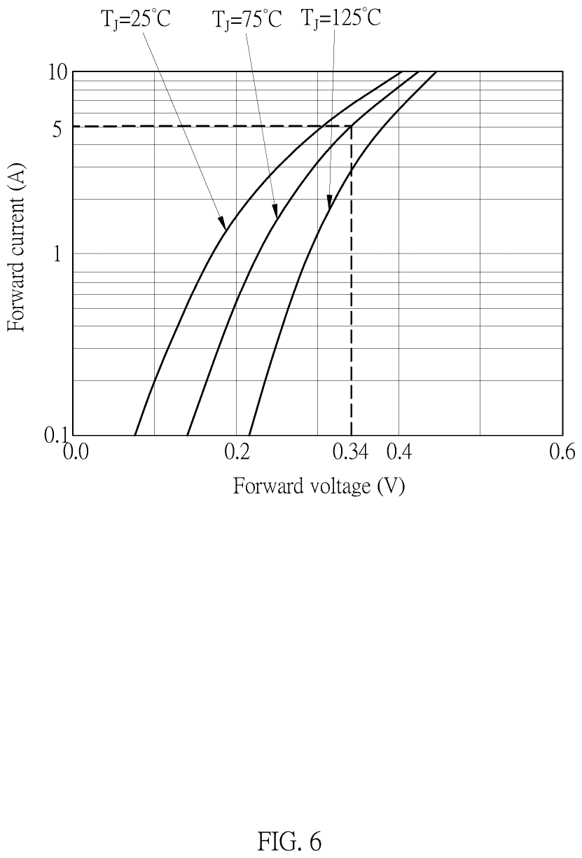

Assuming that the output voltage of the power adapter ADP is 20V, the output voltage of the internal power supply PWR may be designed to be slightly lower than 20V, for example, 19V~19.5V, but not limited to this. It should be noted that high-power Schottky diodes SD1~SD2 may be disposed on the paths of the power adapter ADP and the internal power supply PWR respectively to prevent mutual influence. For example, as shown in FIG. 6, if the material number of the Schottky diodes SD1~SD2 is MBR10U60, when a current of 5 A passes through, the Schottky voltage drop is approximately 0.34V, so the power loss is not large.

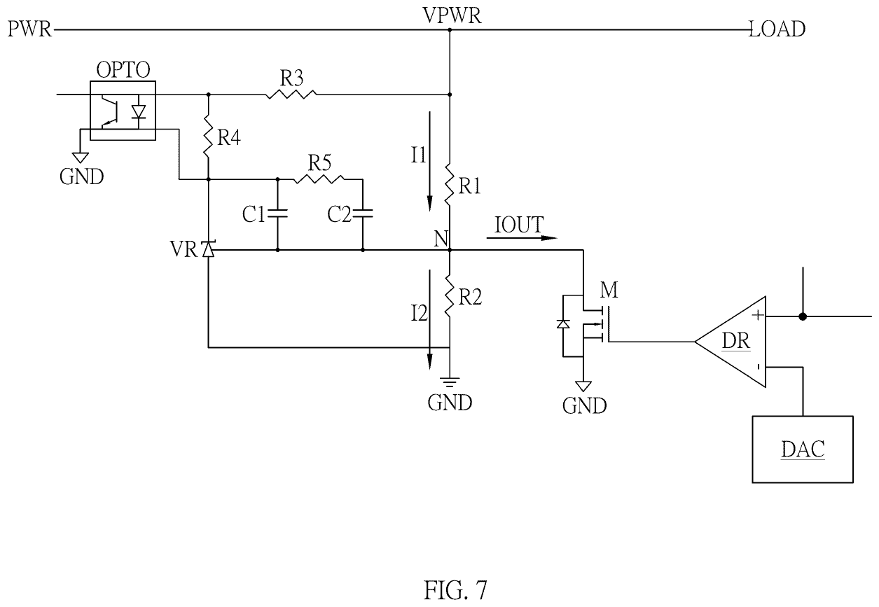

Please refer to FIG. 7. The internal power supply PWR of the display device provides a power supply voltage VPWR to the system load LOAD. The first resistor R1 and the second resistor R2 are connected in series between the power supply voltage VPWR and the ground terminal GND. The power transistor M is electrically connected to a node N between the first resistor R1 and the second resistor R2 and the ground terminal GND respectively, and the control terminal of the power transistor M is electrically connected to the output terminal of the driving circuit DR. The voltage regulator VR is electrically connected between the optical coupler OPTO and the ground terminal GND. The third resistor R3 is electrically connected between the power voltage VPWR and the optical coupler OPTO. The fourth resistor R4 is electrically connected between the optical coupler OPTO and the voltage regulator VR. The fifth resistor R5 is electrically connected to the optical coupler OPTO, the fourth resistor R4 and the voltage regulator VR respectively. One terminal of the first capacitor C1 is electrically connected between the fifth resistor R5 and the optical coupler OPTO, and the other terminal of the first capacitor C1 is electrically connected between the regulator VR and the node N. The second capacitor C2 is electrically connected between the fifth resistor R5 and the node N.

Assuming that the first current flowing through the first resistor R1 is I1, the second current flowing through the second resistor R2 is 12, the output pull current flowing to the power transistor M is IOUT, and the voltage of the node N is 2.5V, the following equations 1~3 can be obtained:

I1=I2+IOUT (Equation 1)

I1=(VPWR−2.5V)/R1 (Equation 2)

I2=2.5V/R2 (Equation 3)

According to the equations 1~3, the power supply voltage VPWR outputted by the internal power supply PWR of the display device can be calculated as:

VPWR=[2.5V*(R1/R2)]+(R1*I0)+2.5V (Equation 4)

In practical applications, since the minimum reference current flowing into the voltage regulator VR is about 2uA, and taking into account the requirements of balancing anti-interference performance and standby power consumption and the influence of the first resistor R1/the second resistor R2 on the feedback response speed of the driving circuit DR, the reference current of the voltage regulator VR is usually set to one hundred times of 2 uA, that is, about 200 uA. Therefore, it can be deduced that the resistance value of the second resistor R2 is 2.5V/200 uA~12.7 K Ω. If the initial output value of the power supply voltage VPWR is 19.5V, it can be deduced that the resistance value of the first resistor R1 is 19.5V*R2/2.5V−R2~86.6 K Ω. It should be noted that in order to make it easier to find the material number of the resistor, the resistance value of the resistor can be set slightly higher, but not limited to this.

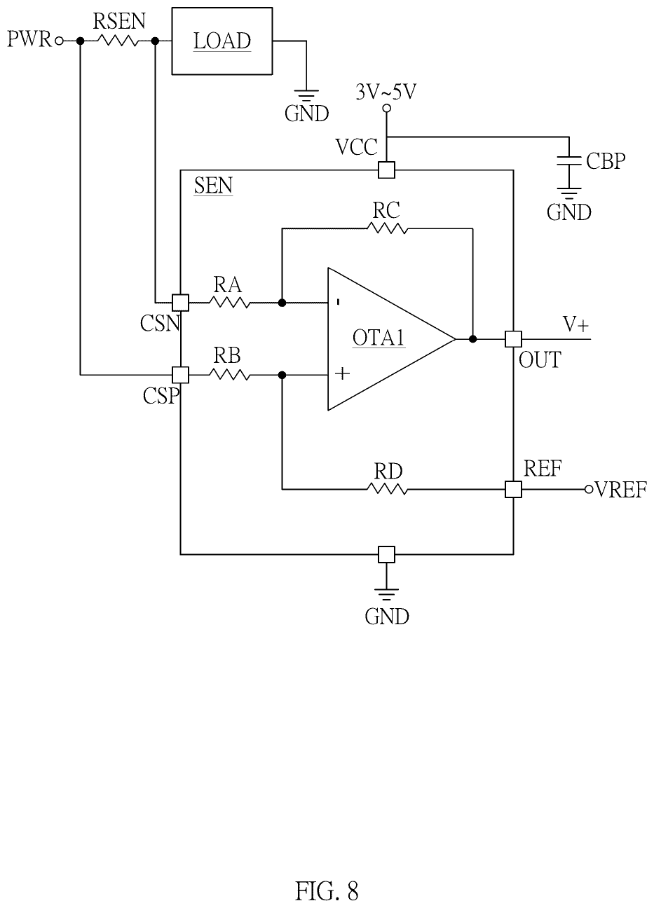

It should be noted that the current sensing circuit SEN of the present disclosure can actually be divided into a high-end current sensing circuit in which the sensing resistor RSEN is disposed between the internal power supply PWR and the system load LOAD, or a low-end current sensing circuit in which the sensing resistor RSEN is disposed between the system load LOAD and the ground terminal GND. For the convenience of circuit layout, the present disclosure adopts a high-side current sensing circuit and can directly select a chip outputting voltage. The detailed circuit structure can refer to the schematic diagram of an embodiment of the current sensing circuit SEN shown in FIG. 8.

As shown in FIG. 8, the current sensing circuit SEN includes an operational transconductance amplifier OTA1, resistors RA~RD, and pins VCC, CSN, CSP, OUT, REF, and GND. The pin VCC is electrically connected to a power voltage (e.g., 3V~5V). The capacitor CBP is electrically connected between a power voltage (e.g., 3V-5V) and a ground terminal GND. The resistor RA is electrically connected between the negative input terminal —of the operational transconductance amplifier OTA1 and the pin CSN. The resistor RB is electrically connected between the positive input terminal+of the operational transconductance amplifier OTA1 and the pin CSP. The output terminal of the operational transconductance amplifier OTA1 is electrically connected to the pin OUT to output a second signal (i.e., the positive input terminal voltage V+). One terminal of the resistor RC is electrically connected to the negative input terminal—of the operational transconductance amplifier OTA1, and the other terminal of the resistor RC is electrically connected to the output terminal of the operational transconductance amplifier OTA1. One terminal of the resistor RD is electrically connected to the positive input terminal+of the operational transconductance amplifier OTA1, and the other terminal of the resistor RD is electrically connected to a pin REF to receive the reference voltage VREF.

The sensing resistor RSEN is electrically connected between the internal power supply PWR and the system load LOAD. The system load LOAD is electrically connected between the sensing resistor RSEN and the ground terminal GND. The pin CSN is electrically connected between the sensing resistor RSEN and the system load LOAD. The pin CSP is electrically connected between the internal power supply PWR and the sensing resistor RSEN. It should be noted that the design of the sensing resistor RSEN depends on the sensing current, the maximum current sensing voltage range between the pins CSP and CSN, the reference voltage VREF, and the power voltage VCC. For unidirectional current applications, assuming that the range of the sensing current ISEN is OA~ImaxP and the maximum current sensing voltage range between pins CSP and CSN is −10 mV~10 mV, the maximum sensing resistance value at the input end is Rmax1=10 mV/ImaxP. Since the second signal output from pin OUT (i.e., the positive input voltage V+) is clamped between the ground terminal GND and (VCC−0.2V), the maximum sensing resistance value of the output terminal is Rmax2=(VCC−0.2V-−REF)/Gain/ImaxP, so the smaller value of Rmax1 and Rmax2 can be selected as the maximum available current sensing resistance value.

Thus, the second signal (i.e., the positive input terminal voltage V+) received by the driving circuit DR is outputted by the pin OUT of the current sensing circuit SEN. According to the sensing current ISEN=VOUT/Gain/RSEN, the positive input terminal voltage V+=VOUT=ISEN*RSEN*Gain of the driving circuit DR can be obtained. The positive input terminal voltage V+ of the driving circuit DR represents the actual load current value on the line of the power adapter ADP, and has a certain positive proportional multiple relationship with the actual current value. The negative input voltage V− of the driving circuit DR represents the expected maximum load IMAX_PDO of the power adapter ADP. When the system is stable under the condition of the maximum load value of the power adapter ADP, the negative input voltage V− provided by the digital-to-analog converter DAC to the driving circuit DR needs to be fixed at V−=IMAX_PDO*RSEN*Gain.

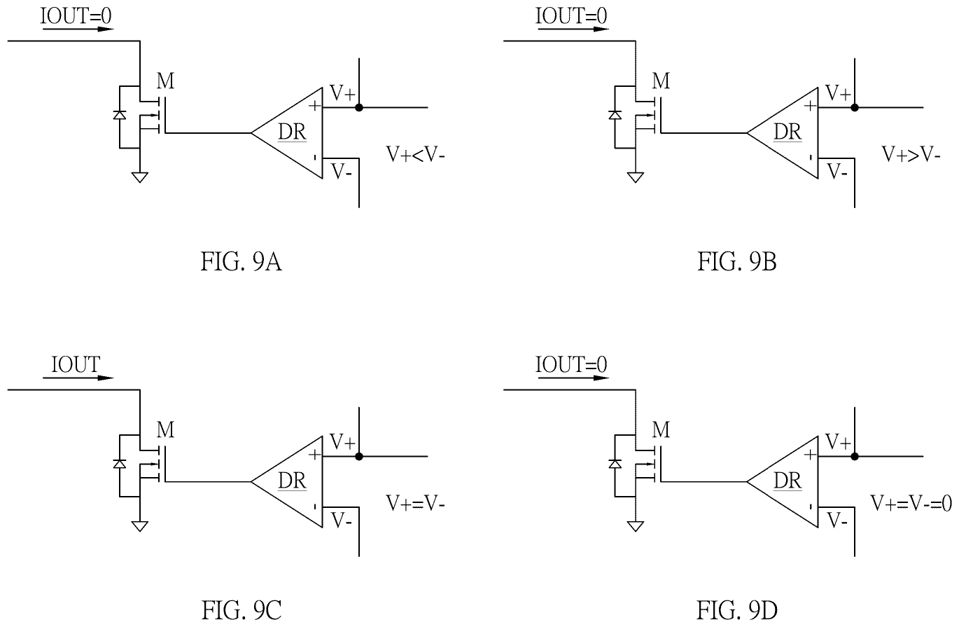

Please refer to FIG. 9A. When the power adapter ADP is connected to the interface Type-C IN, the system load LOAD is a light load, that is, the actual current on the PD path of the power adapter ADP does not reach the maximum PD capacity of the power adapter ADP itself. The second signal received by the driving circuit DR (that is, the positive input terminal voltage V+ ) is less than the first signal (that is, the negative input terminal voltage V−), and the output pull current IOUT of the driving circuit DR is equal to 0. At this time, since the output of the internal power supply PWR is slightly lower than the output of the power adapter ADP, the internal power supply PWR is almost not loaded, and the system load LOAD is almost all powered by the power adapter ADP connected to the interface Type-C IN.

Please refer to FIG. 9B. When the power adapter ADP is connected to the interface Type-C IN, the system load LOAD is overloaded, that is, the actual current on the path of the power adapter ADP exceeds the maximum PD capacity of the power adapter ADP itself, the second signal (that is, the positive input terminal voltage V+) received by the driving circuit DR is greater than the first signal (that is, the negative input terminal voltage V−), and the output pull current IOUT of the driving circuit DR is greater than 0. The output voltage of the internal power supply PWR becomes higher, which increases the load of the internal power supply PWR and relatively reduces the load of the power adapter ADP connected to the interface Type-C IN, thereby preventing the load of the power adapter ADP connected to the interface Type-C IN from continuing to increase.

As shown in FIG. 9C, when the power adapter ADP is connected to the interface Type-C IN, it will be eventually stable in a state that the second signal (i.e., the positive input terminal voltage V+) received by the driving circuit DR is equal to the first signal (i.e., the negative input terminal voltage V−), that is, the load of the power adapter ADP will be stabled at the current value in its maximum PDO (e.g., 5V).

As shown in FIG. 9D, when the power adapter ADP is not connected to the interface Type-C IN, the first signal (i.e., the negative input terminal voltage V−) and the second signal (i.e., the positive input terminal voltage V+) received by the driving circuit DR are both equal to 0. At this time, the system load LOAD is powered by the internal power supply PWR.

According to FIG. 9A to FIG. 9D, when the power adapter ADP is electrically connected to the display device, the PD capability of the power adapter ADP is fully used in the present disclosure to save the power supply of the internal power supply PWR as much as possible and the heat dissipation effect in the display device can be improved.

According to a specific embodiment of the present disclosure, a method for operating a display device with multi-PD function is provided. In this embodiment, the display device includes an internal power supply, a system load, an interface and a power synergy control circuit. The operation method first determines whether the interface has PD capability to generate a first signal, and senses the power supply on the PD path between the interface and the system load to generate a second signal, and then selectively determines whether the internal power supply and/or the interface is used to provide power to the system load according to the first signal and the second signal.

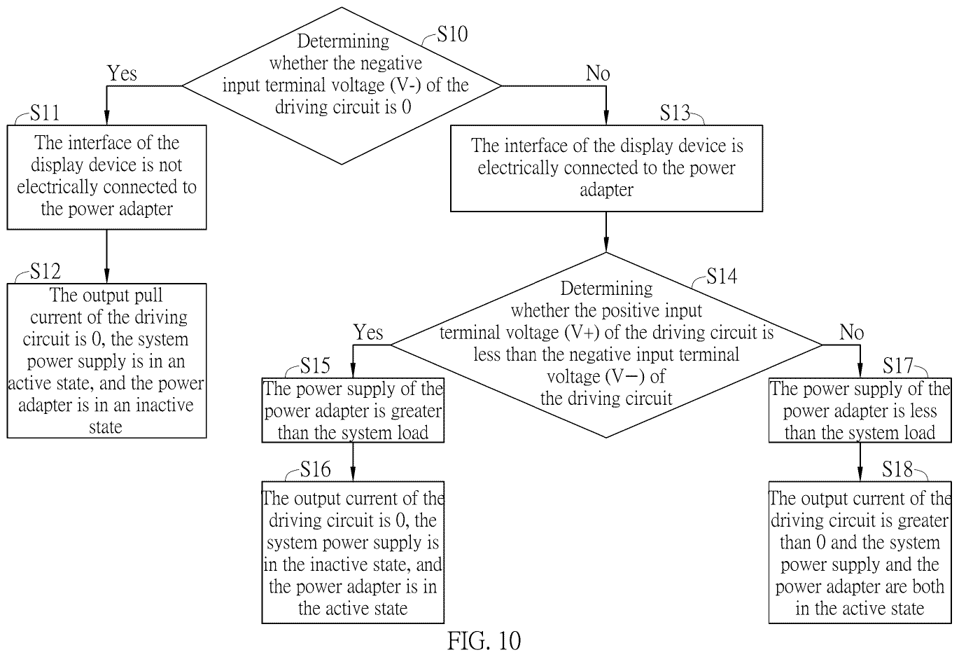

In one embodiment, as shown in FIG. 10, the operating method of the display device with multi-PD function first determines whether the negative input terminal voltage (V−) of the driving circuit (DR) is 0 (step S10). In response to that the determination result of the step S10 is yes, that is, the negative input terminal voltage (V−) of the driving circuit (DR) is 0, and the positive input terminal voltage (V+) of the driving circuit (DR) is also 0, indicating that the interface of the display device is not electrically connected to the power adapter (step S11), so the system load of the display device is powered by the internal power supply. At this time, the output pull current (IOUT) of the driving circuit (DR) is 0, the system power supply is in an active state, and the power adapter is in an inactive state (step S12).

In response to that the determination result of the step S10 is no, that is, the negative input voltage (V−) of the driving circuit (DR) is not 0, it means that the interface of the display device is electrically connected to the power adapter (step S13). At this time, the display device operation method further determines whether the positive input terminal voltage (V+) of the driving circuit (DR) is less than the negative input terminal voltage (V−) of the driving circuit (DR) (step S14).

In response to that the determination result of the step S14 is yes, that is, the positive input terminal voltage (V+) of the driving circuit (DR) is less than the negative input terminal voltage (V−) of the driving circuit (DR), it means that the system load at this time is light load, that is, the power supply of the power adapter is greater than the system load (step S15), so the system load can be powered by the power adapter externally connected to the interface, and it is not necessary to provide power to the system load from the internal power supply of the display device. At this time, the output current (IOUT) of the driving circuit (DR) is 0, the system power supply is in the inactive state, and the power adapter is in the active state (step S16).

In response to that the determination result of the step S14 is no, that is, the positive input terminal voltage (V+) of the driving circuit (DR) is greater than or equal to the negative input terminal voltage (V−) of the driving circuit (DR), it means that the system load at this time is heavy load, that is, the power supply of the power adapter is less than the system load (step S17), so the power required for the system load needs to be shared by the power adapter connected to the interface and the internal power supply of the display device. At this time, the output current of the driving circuit is greater than 0 and the system power supply and the power adapter are both in the active state (step S18).

In summary, the display device with multi-PD function and the operation method thereof proposed in the present disclosure fully utilize the PD capacity of idle power adapters through power synergy technology to effectively increase the total power supply of the display device, so that the display device can provide power to multiple external devices simultaneously to realize the multi-PD function, and the generation of electronic waste can be greatly reduced and the large amount of materials and energy consumed in manufacturing new power adapters and the emission of greenhouse gases such as carbon dioxide can be also reduced, thereby the goals of resource conservation and efficient utilization and carbon footprint reduction can be achieved. It is helpful for enterprises to practice the ESG concepts of environmental protection, social responsibility and corporate governance on the basis of innovative technologies. In addition, the display device with multi-PD function and the operating method thereof proposed in the present disclosure also adjust the feedback point of the internal power supply of the display device to sink current or pull current to reduce or increase the outputted power, so that the power supply required by the system load can be shared by the external power adapter electrically connected through the interface of the display device with the internal power supply of the display device, thereby effectively improving the power management and heat dissipation efficiency of the display device and achieving the lowest cost solution.

The contents disclosed above are merely feasible embodiments of the present disclosure, and are not intended to limit the scope of the claims of the present disclosure. Therefore, all equivalent technical changes made based on the specification and the drawings of the present disclosure fall within the scope of the claims of the present disclosure.

1. A display device with multi-power delivery (PD) function, comprising:
an internal power supply;
a system load;
an interface; and
a power synergy control circuit electrically connected to the internal power supply, the system load and the interface respectively, the power synergy control circuit comprising:
a first processing circuit electrically connected to the interface and configured to determine whether the interface has PD capability and generate a first signal accordingly;
a second processing circuit electrically connected to a PD path between the interface and the system load and configured to sense a power supply on the PD path and generate a second signal accordingly; and
a driving circuit electrically connected to the first processing circuit and the second processing circuit respectively and configured to selectively determine the internal power supply and/or the interface to provide power to the system load according to the first signal and the second signal,
wherein in response to that the interface does not have the PD capability, the internal power supply provides power to the system load through a power transistor.

2. The display device according to claim 1, wherein the driving circuit comprises:
an operational transconductance amplifier having a first input terminal, a second input terminal and an output terminal, the first input terminal is electrically connected to the first processing circuit and receives the first signal, the second input terminal is electrically connected to the second processing circuit and receives the second signal, the operational transconductance amplifier is configured to compare the first signal with the second signal, and output an output current through the output terminal according to a comparison result of the first signal and the second signal.

3. The display device according to claim 2, wherein in response to the comparison result that the second signal is greater than the first signal, the output current is a pull current.

4. The display device according to claim 2, wherein in response to the comparison result that the second signal is smaller than the first signal, the output current is a sink current.

5. The display device according to claim 1, wherein the first processing circuit comprises:
a power supply control circuit electrically connected to the interface and configured to obtain a PD capability information of the interface and determine whether the interface has the PD capability accordingly; and
a digital-to-analog converter electrically connected to the power supply control circuit and the driving circuit respectively and configured to generate the first signal to the driving circuit according to the PD capability information.

6. The display device according to claim 5, wherein the PD capability information comprises a maximum power data object (PDO) of the interface, the digital-to-analog converter generates a standard reference voltage that is proportional to a current value in the maximum PDO as the first signal according to the current value and outputs the first signal to the driving circuit.

7. The display device according to claim 1, wherein the second processing circuit comprises:
a sensing resistor disposed on the PD path between the interface and the system load; and
a current sensing circuit electrically connected to two terminals of the sensing resistor and the driving circuit, and the current sensing circuit is configured to sense a power supply current flowing through the two terminals of the sensing resistor and convert the power supply current into a voltage signal as the second signal and outputs the second signal to the driving circuit.

8. The display device according to claim 7, wherein the power synergy control circuit also comprises:
a first high-power Schottky diode disposed on the PD path and between the interface and the sensing resistor; and
a second high-power Schottky diode disposed between the internal power supply and the system load,
wherein the power transistor is electrically connected to two terminals of the second high-power Schottky diode respectively.

9. The display device according to claim 8, wherein the power transistor is turned on, so the internal power supply provides power to the system load through the turned-on power transistor.

10. The display device according to claim 8, wherein in response to that the interface has the PD capability and the comparison result is that the second signal is smaller than the first signal, the driving circuit determines that the interface and the internal power supply jointly provide power to the system load, and the power transistor is turned off, so the internal power supply provides power to the system load through the second high-power Schottky diode.

11. The display device according to claim 8, wherein in response to that the interface has the PD capability and the comparison result is that the second signal is greater than the first signal, the driving circuit determines that the interface provides power to the system load through the PD path.

12. An operating method of a display device with multi-power delivery (PD) function, the display device comprising an internal power supply, a system load, an interface and a power synergy control circuit, the operating method comprising:
determining whether the interface has PD capability through the power synergy control circuit and generating a first signal accordingly;
sensing a power supply on a PD path between the interface and the system load and generating a second signal accordingly;
selectively determining the internal power supply and/or the interface to provide power to the system load according to the first signal and the second signal; and
in response to that the interface does not have the PD capability, determining that the internal power supply provides power to the system load through a power transistor.

13. The operating method according to claim 12, further comprising:
comparing the first signal and the second signal to generate a comparison result; and
generating an output current according to the comparison result.

14. The operating method according to claim 13, wherein in response to the comparison result that the second signal is greater than the first signal, the output current is a pull current.

15. The operating method according to claim 13, wherein in response to the comparison result that the second signal is smaller than the first signal, the output current is a sink current.

16. The operating method according to claim 12, further comprising:
obtaining a PD capability information of the interface and determining whether the interface has the PD capability accordingly; and
generating the first signal to the driving circuit according to the PD capability information.

17. The operating method according to claim 16, wherein the PD capability information comprises a maximum power data object (PDO) of the interface, the operating method further comprises:
generating a standard reference voltage that is proportional to a current value in the maximum PDO as the first signal according to the current value and outputs the first signal to the driving circuit.

18. The operating method according to claim 12, wherein a sensing resistor is disposed on the PD path between the interface and the system load, and the operating method further comprises:
sensing a power supply current flowing through two terminals of the sensing resistor; and
converting the power supply current into a voltage signal as the second signal.

19. The operating method according to claim 18, wherein a first high-power Schottky diode is disposed between the interface and the sensing resistor on the PD path, and a second high-power Schottky diode is disposed between the internal power supply and the system load, and two terminals of the second high-power Schottky diode are electrically connected to the power transistor, and the operating method further comprises:
controlling the power transistor to be turned on, so the internal power supply provides power to the system load through the turned-on power transistor.

20. The operating method according to claim 19, further comprising:
in response to that the interface has the PD capability and the comparison result that the second signal is smaller than the first signal, determining that the interface and the internal power supply jointly provide power to the system load, and controlling the power transistor to be turned off, so the internal power supply providing power to the system load through the second high-power Schottky diode; and
in response to that the interface has the PD capability and the comparison result that the second signal is greater than the first signal, determining that the interface provides power to the system load through the PD path.
